(19) United States
(12) Patent Application Publication
(10) Pub. No.: US 2026/0251991 A1
(43) Pub. Date: Aug. 27, 2026

(54) TONER

(71) Applicant: KYOCERA Document Solutions Inc., Osaka (JP)

(72) Inventor: Hiroki UEMURA, Osaka (JP)

(73) Assignee: KYOCERA Document Solutions Inc., Osaka (JP)

(21) Appl. No.: 19/544,271

(22) Filed: Feb. 19, 2026

(30) Foreign Application Priority Data
Feb. 25, 2025 (JP) 2025-028049

(51) Int. Cl. G03G 9/083; G03G 9/087; G03G 9/093

(52) U.S. Cl. CPC G03G 9/0834; G03G 9/08755; G03G 9/09342

(57) ABSTRACT

A toner includes a toner particle. The toner particle includes a toner core. The toner core contains a binding resin, a magnetic particle and a carbon nanotube. The content of the magnetic particle in the toner core is equal to or greater than 30.0% by mass and equal to or less than 50.0% by mass, and the content of the carbon nanotube in the toner core is equal to or greater than 0.10% by mass and equal to or less than 1.00% by mass.

### INCORPORATION BY REFERENCE

This application is based upon and claims the benefit of priority from the corresponding Japanese Patent Application No. 2025-028049 filed on Feb. 25, 2025, the entire contents of which are incorporated herein by reference.

### BACKGROUND

The present disclosure relates to toners.

Conventionally, in order to satisfy low-temperature fixability in a recycling system, a toner is disclosed which includes a binding resin containing a predetermined low-molecular resin component, a colorant and a mold release agent. The resin softening coefficient A of the predetermined low-molecular resin component satisfies a formula “A>0.165”. When an outflow start temperature measured with a melt flow tester is assumed to be Tfb, the storage elastic modulus G′(Tfb) of the predetermined low-molecular resin component satisfies a formula “G′(Tfb)≤1×10⁴”.

However, such a toner is insufficient in terms of stably charging the toner and forming high-quality images when an environment such as temperature and humidity changes.

### SUMMARY

A toner in the present disclosure includes a toner particle. The toner particle includes a toner core. The toner core contains a binding resin, a magnetic particle and a carbon nanotube. The content of the magnetic particle in the toner core is equal to or greater than 30.0% by mass and equal to or less than 50.0% by mass, and the content of the carbon nanotube in the toner core is equal to or greater than 0.10% by mass and equal to or less than 1.00% by mass.

### BRIEF DESCRIPTION OF THE DRAWINGS

FIG. 1 is a diagram showing the cross-sectional structure of a non-encapsulated toner particle which is an example of a toner particle included in a toner in an embodiment of the present disclosure; and

FIG. 2 is a diagram showing the cross-sectional structure of an encapsulated toner particle which is another example of the toner particle included in the toner in the embodiment of the present disclosure.

### DETAILED DESCRIPTION

Although an embodiment of the present disclosure will be described in detail below, the present disclosure is not limited to the following embodiment at all, and can be implemented by performing an appropriate modification within the scope of the object of the present disclosure. Although repeated description may be omitted as necessary, this omission is not intended to limit the gist of the invention.

Terms which are used in the present embodiment will first be described. A toner is an aggregate of toner particles (for example, powder). A magnetic particle is an aggregate of magnetic particles (for example, powder). An external additive is an aggregate of external additive particles (for example, powder). Each of the results of evaluations (values indicating shapes, physical properties and the like) on powder (more specifically, such as the powder of the toner particles or the powder of the external additive particles) is the number average of values obtained by performing a measurement on each of a considerable number of particles selected from the powder unless otherwise specified. Unless otherwise specified, a volume median diameter (D₅₀) is a median diameter measured using a laser diffraction/scattering particle size distribution measuring device (“LA-950” made by HORIBA, Ltd.). Unless otherwise specified, a number average primary particle diameter is the number average value of the circle-equivalent diameters (Heywood diameter: the diameter of a circle having the same area as the projected area of a primary particle) of primary particles measured using a field emission scanning electron microscope (“JSM-6700F” made by JEOL Ltd.) The number average primary particle diameter is, for example, the number average value of the circle-equivalent diameters of 50 primary particles.

Unless otherwise specified, a softening point (Tm) is a value measured using a melt flow tester (“CFT-500D” made by Shimadzu Corporation). In an S-shaped curve (horizontal axis: temperature, vertical axis: stroke) measured with the melt flow tester, the temperature at which “(baseline stroke value+maximum stroke value)/2” is reached corresponds to Tm (softening point). A glass transition point (Tg) is a value determined from a change point in the specific heat of the binding resin using a differential scanning calorimeter (DSC). More specifically, a differential scanning calorimeter (“DSC-6220” made by Seiko Instruments Inc.) is used as a measuring device, the endothermic curve of a measurement target is measured by the following method and thus it is possible to determine the glass transition point of the measurement target. 10 mg of the measurement target is placed in an aluminum pan. An empty aluminum pan is used as a reference. The measurement is performed at normal temperature and normal humidity under conditions of a measurement temperature range which is equal to or greater than 25° C. and equal to or less than 200° C. and a heating rate of 10° C./minute, and thus it is possible to determine the glass transition point of the measurement target from the endothermic curve of the measurement target obtained.

Unless otherwise specified, an acid value is a value measured in accordance with JIS (Japanese Industrial Standards) K0070-1992. Unless otherwise specified, a number average molecular weight (Mn) and a mass average molecular weight (Mw) are values measured using gel permeation chromatography (GPC). For example, the number average molecular weight (Mn) and the mass average molecular weight (Mw) can be determined using a calibration curve prepared in advance using a standard polystyrene resin. Unless otherwise specified, a nitrogen adsorption specific surface area is a value measured in accordance with JIS (Japanese Industrial Standards) K6217. Unless otherwise specified, a DBP absorption amount is a value measured in accordance with JIS (Japanese Industrial Standards) K6221. Unless otherwise specified, a relative humidity is a value measured in accordance with JIS (Japanese Industrial Standards) Z8806: 2001.

A compound and its derivative may be collectively referred to by adding the term “-based” to the end of the name of the compound. When the name of a polymer is expressed by adding “-based” to the end of the name of a compound, it means that the repeating unit of the polymer is derived from the compound or its derivative. Acrylic and methacrylic may be collectively referred to as “(meth)acrylic”. Acrylonitrile and methacrylonitrile may be collectively referred to as “(meth)acrylonitrile”. Acrylate and methacrylate may be collectively referred to as “(meth)acrylate”. Unless otherwise specified, each of components described in the present specification may be used alone or in a combination of two or more thereof. The terms used in the present embodiment have been described above.

### [Toner]

A toner in the present embodiment includes a toner particle. The toner particle includes a toner core. The toner core contains a binding resin, a magnetic particle and a carbon nanotube. The content of the magnetic particle in the toner core is equal to or greater than 30.0% by mass and equal to or less than 50.0% by mass, and the content of the carbon nanotube in the toner core is equal to or greater than 0.10% by mass and equal to or less than 1.00% by mass.

The toner in the present embodiment has the configuration described above, and thereby has excellent fixability (for example, low-temperature fixability and a fixation rate to a recording medium), can be charged to a desired charge amount and can form images with a desired density and a small amount of fog even when images are continuously formed under various environments such as a normal temperature and normal humidity environment, a high temperature and high humidity environment and a low temperature and low humidity environment. The reason for this is presumed to be as follows.

In the present embodiment, the toner core contains the carbon nanotube. The content of the carbon nanotube in the toner core is equal to or greater than 0.10% by mass. Since the carbon nanotube has high electrical conductivity, when the toner is triboelectrically charged in the development unit of an image forming apparatus, the toner particles are charged satisfactorily and triboelectrically even under various environments. Consequently, even when images are formed continuously under various environments, the toner can be charged to the desired charge amount, and images of the desired density can be formed. Since the carbon nanotube has high electrical conductivity, charge is rapidly transferred between the toner particles even under various environments. Consequently, the distribution of the charge amount of toner becomes sharp, and even when images are continuously formed under various environments, images with a small amount of fog can be formed.

On the other hand, when the content of the carbon nanotube in the toner core is excessively high, charge is excessively removed from the triboelectrically charged toner. Hence, the content of the carbon nanotube in the toner core is set equal to or less than 1.00% by mass. Consequently, it is possible to suppress the excessive removal of charge from the triboelectrically charged toner, and to suppress an excessive decrease in the charge amount of the toner.

The carbon nanotube has high thermal conductivity in addition to high electrical conductivity. Hence, when the toner is fixed to the recording medium, heat of a fixing device in the image forming apparatus is rapidly conducted. Consequently, the low-temperature fixability of the toner and the fixation rate of the toner to the recording medium are enhanced.

The reason why the toner in the present embodiment has excellent fixability, can be charged to the desired charge amount and can form images with the desired density and a small amount of fog even when images are continuously formed under various environments such as a normal temperature and normal humidity environment, a high temperature and high humidity environment and a low temperature and low humidity environment has been described above.

The toner in the present embodiment is suitably used for development of an electrostatic latent image, for example, as a positively charged toner. The toner may be used as a one-component developer. The toner may be mixed with a carrier using a mixing device (for example, a ball mill) to be used as a two-component developer. When the toner is used as a one-component developer, the toner is charged by friction with a development sleeve or a toner charging member in a development device. An example of the toner charging member is a doctor blade. When the toner is used as a two-component developer, the toner is charged by friction with the carrier in the development device. The details of the toner in the present embodiment will be further described below.

### <Structure of Toner Particle>

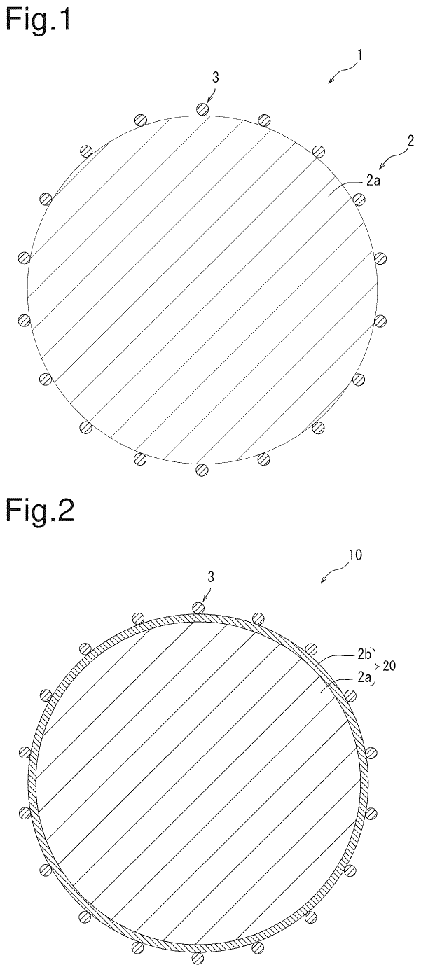

The toner particle is a non-encapsulated toner particle or an encapsulated toner particle. The structure of the toner particle included in the toner will be described below with reference to FIGS. 1 and 2. FIG. 1 shows the cross-sectional structure of the non-encapsulated toner particle 1 which is an example of the toner particle included in the toner in the present embodiment. FIG. 2 shows the cross-sectional structure of the encapsulated toner particle 10 which is another example of the toner particle included in the toner in the present embodiment.

A case where the toner particle is the non-encapsulated toner particle 1 will first be described. As shown in FIG. 1, the non-encapsulated toner particle 1 includes a toner base particle 2 and external additive particles 3. In the following description, the “toner base particle 2 included in the non-encapsulated toner particle 1” may be referred to as the “non-encapsulated toner base particle 2”. The external additive particles 3 are adhered to the surface of the non-encapsulated toner base particle 2. The non-encapsulated toner base particle 2 includes the toner core 2a. The non-encapsulated toner base particle 2 does not include a shell layer 2b (see FIG. 2), and the toner core 2a corresponds to the non-encapsulated toner base particle 2. In other words, the toner core 2a which is not covered by the shell layer 2b corresponds to the non-encapsulated toner base particle 2.

A case where the toner particle is the encapsulated toner particle 10 will then be described. As shown in FIG. 2, the encapsulated toner particle 10 includes a toner base particle 20 and the external additive particles 3. In the following description, the “toner base particle 20 included in the encapsulated toner particle 10” may be referred to as the “encapsulated toner base particle 20”. The external additive particles 3 are adhered to the surface of the encapsulated toner base particle 20. The encapsulated toner base particle 20 includes the toner core 2a and the shell layer 2b which covers the surface of the toner core 2a. The shell layer 2b may cover the entire surface of the toner core 2a. The shell layer 2b does not need to include projections and recesses. Although the thickness of the shell layer 2b is not particularly limited, the thickness is preferably equal to or greater than 0.03 μm and equal to or less than 1 μm, more preferably equal to or greater than 0.04 μm and equal to or less than 0.7 μm, particularly preferably equal to or greater than 0.05 μm and equal to or less than 0.5 μm and most preferably equal to or greater than 0.05 μm and equal to or less than 0.3 μm.

Although the structure of the toner particle has been described above, the structure of the toner particle included in the toner in the present embodiment is not limited to the structure shown in FIGS. 1 and 2. For example, the non-encapsulated toner particle 1 does not need to include the external additive particles 3. When the non-encapsulated toner particle 1 does not include the external additive particles 3, the non-encapsulated toner base particle 2 corresponds to the non-encapsulated toner particle 1. For example, the encapsulated toner particle 10 does not need to include the external additive particles 3. When the encapsulated toner particle 10 does not include the external additive particles 3, the encapsulated toner base particle 20 corresponds to the encapsulated toner particle 10. For example, the shell layer 2b may cover a part of the surface of the toner core 2a instead of the entire surface of the toner core 2a. The state of the adhesion of the external additive particles 3 and the state of the covering of the shell layer 2b can be confirmed using a scanning electron microscope (SEM). For example, the surface of the shell layer 2b may include projections and recesses. When the shell layer 2b is formed of resin particles, projections and recesses caused by the shape of the resin particles are formed in the surface of the shell layer 2b. The degree of smoothness of the shell layer 2b can be confirmed by observing the cross section of the encapsulated toner particle 10 using a transmission electron microscope (TEM). In the following description, the non-encapsulated toner particle 1 and the encapsulated toner particle 10 may be collectively referred to as the “toner particle”. The non-encapsulated toner base particle 2 and the encapsulated toner base particle 20 may be collectively referred to as the “toner base particle”. The structure of the toner particle included in the toner has been described above with reference to FIGS. 1 and 2. Methods for manufacturing the toner core, the shell layer, the external additive and the toner will be described below.

### <Toner Core>

The toner core included in the toner particle contains the binding resin, the magnetic particle and the carbon nanotube. The toner core may further contain internal additives (for example, a mold release agent, a charge control agent and at least one of other known additives) as necessary. In order to obtain the toner suitable for image formation, the volume median diameter (D₅₀) of the toner core is preferably equal to or greater than 4 μm and equal to or less than 9 μm.

### (Binding Resin)

Examples of the binding resin include a thermoplastic resin. Examples of the thermoplastic resin include styrene resin, acrylic resin, styrene-acrylic resin, polyethylene resin, polypropylene resin, vinyl chloride resin, polyester resin, polyamide resin, polyurethane resin, polyvinyl alcohol resin, vinyl ether resin, N-vinyl resin and styrene-butadiene resin. Among these resins, polystyrene resin and polyester resin are preferable in terms of the dispersibility of the magnetic particles in the binding resin, the chargeability of the toner and fixability to the recording medium. The polystyrene resin and the polyester resin will be described below.

The polystyrene resin may be a homopolymer of styrene or a copolymer of styrene and another monomer copolymerizable with styrene. Examples of the monomer copolymerizable with styrene include p-chlorostyrene, vinylnaphthalene, ethylenically unsaturated monoolefin, vinyl halide, vinyl ester, (meth)acrylic acid ester, other acrylic acid derivatives, vinyl ketone and N-vinyl compound. Examples of the ethylenically unsaturated monoolefin include ethylene, propylene, butylene and isobutylene. Examples of the vinyl halide include vinyl chloride, vinyl bromide and vinyl fluoride. Examples of the vinyl ester include vinyl acetate, vinyl propionate, vinyl benzoate and vinyl butyrate. Examples of the (meth)acrylic acid ester include methyl acrylate, ethyl acrylate, n-butyl acrylate, isobutyl acrylate, dodecyl acrylate, n-octyl acrylate, 2-chloroethyl acrylate, phenyl acrylate, methyl α-chloroacrylate, methyl methacrylate, ethyl methacrylate and butyl methacrylate. Examples of the other acrylic acid derivatives include acrylonitrile, methacrylonitrile and acrylamide. Examples of the vinyl ether include vinyl methyl ether and vinyl isobutyl ether. Examples of the vinyl ketone include vinyl methyl ketone, vinyl ethyl ketone and methyl isopropenyl ketone. Examples of the N-vinyl compound include N-vinylpyrrole, N-vinylcarbazole, N-vinylindole and N-vinylpyrrolidene.

The polyester resin is obtained by polycondensation of a divalent or trivalent or higher alcohol monomer and a divalent or trivalent or higher carboxylic acid monomer.

Examples of the divalent alcohol monomer include diol and bisphenol. Examples of the diol include ethylene glycol, diethylene glycol, triethylene glycol, 1,2-propanediol, 1,3-propanediol, 1,4-butanediol, neopentyl glycol, 2-butene-1,4-diol, 1,5-pentanediol, 1,6-hexanediol, 1,4-cyclohexanedimethanol, dipropylene glycol, polyethylene glycol, polypropylene glycol and polytetramethylene glycol. Examples of the bisphenol include bisphenol A, hydrogenated bisphenol A, bisphenol A ethylene oxide adduct and bisphenol A propylene oxide adduct.

Examples of the trivalent or higher alcohol monomer include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane and 1,3,5-trihydroxymethylbenzene.

Examples of the divalent carboxylic acid monomer include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, alkylsuccinic acids (more specifically, n-butylsuccinic acid, isobutylsuccinic acid, n-octylsuccinic acid, n-dodecylsuccinic acid, isododecylsuccinic acid and the like) and alkenylsuccinic acids (more specifically, n-butenylsuccinic acid, isobutenylsuccinic acid, n-octenylsuccinic acid, n-dodecenylsuccinic acid, isododecenylsuccinic acid and the like).

Examples of the trivalent or higher carboxylic acid monomer include 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid and empol trimer acid.

The divalent or trivalent or higher carboxylic acid monomer may be used after being derivatized into an ester-forming derivative (more specifically, acid halide, acid anhydride, a lower alkyl ester or the like). Here, the term “lower alkyl” means an alkyl group having 1 to 6 carbon atoms.

The polyester resin is preferably a condensation polymer of at least one bisphenol, at least one divalent acid monomer and at least one trivalent or higher acid monomer. More preferably, the polyester resin is a polycondensation product of a bisphenol A ethylene oxide adduct, a bisphenol A propylene oxide adduct, terephthalic acid, an alkenylsuccinic acid, and trimellitic acid.

The softening point of the binding resin is preferably equal to or greater than 70° C. and equal to or less than 130° C., and is more preferably equal to or greater than 80° C. and equal to or less than 120° C.

The glass transition point (Tg) of the binding resin is preferably equal to or greater than 40° C. and equal to or less than 70° C. As the glass transition point is lower, the low-temperature fixability of the toner tends to be enhanced. As the glass transition point is higher, the heat resistant storability of the toner tends to be enhanced.

Although the mass average molecular weight (Mw) of the binding resin is not particularly limited, the mass average molecular weight (Mw) is preferably equal to or greater than 20,000 and equal to or less than 300,000, and more preferably equal to or greater than 30,000 and equal to or less than 200,000.

When the binding resin is the polystyrene resin, the polystyrene resin preferably has peaks in both a low molecular weight region and a high molecular weight region in a molecular weight distribution measured by gel permeation chromatography or the like. Specifically, the polystyrene resin preferably has the peak in the low molecular weight region in a molecular weight range equal to or greater than 3,000 and equal to or less than 20,000, and preferably has the peak in the high molecular weight region in a molecular weight range equal to or greater than 300,000 and equal to or less than 1,500,000. In the polystyrene resin having the molecular weight distribution as described above, the ratio (Mw/Mn) of the number average molecular weight (Mn) to the mass average molecular weight (Mw) is preferably equal to or greater than 10. The polystyrene resin has the peak in the low molecular weight region and the peak in the high molecular weight region in such regions, and thus it is possible to obtain the toner which has excellent fixability and can suppress a high temperature offset.

Since the fixability to the recording medium is satisfactory, as the binding resin, the thermoplastic resin which has already been described is preferable. However, instead of using the thermoplastic resin alone, a crosslinking agent or a thermosetting resin may be added to the thermoplastic resin. By adding a crosslinking agent or a thermosetting resin to introduce a partially crosslinked structure into the binding resin, the heat resistant storability and the durability of the toner can be enhanced without the fixability of the toner being lowered. When a thermosetting resin is used, the amount of crosslinked portions (gel amount) of the binding resin extracted using a Soxhlet extractor is preferably equal to or less than 10% by mass relative to the mass of the binding resin, and more preferably equal to or greater than 0.1% by mass and equal to or less than 10% by mass.

Examples of the thermosetting resin which can be used together with the thermoplastic resin include epoxy resin and cyanate resin, and epoxy resin is preferable. Examples of the epoxy resin include bisphenol A type epoxy resin, hydrogenated bisphenol A type epoxy resin, novolac type epoxy resin, polyalkylene ether type epoxy resins and cycloaliphatic type epoxy resin.

### (Carbon Nanotube)

As already described, the toner core included in the toner particle contains the carbon nanotube. Although the carbon nanotube is internally added into the toner base particle (in particular, the toner core), since the carbon nanotube is unlikely to be affected by an environmental change, the carbon nanotube is preferably prevented from being externally added to the toner base particle. In other words, the toner particle is preferably prevented from including the carbon nanotube as an external additive.

As already described, the content of the carbon nanotube in the toner core is equal to or greater than 0.10% by mass and equal to or less than 1.00% by mass. In order to provide the toner which has excellent fixability, can be charged to the desired charge amount and can form images with the desired density and a small amount of fog even when images are continuously formed under various environments, the content of the carbon nanotube in the toner core is preferably equal to or greater than 0.20% by mass and equal to or less than 0.90% by mass, more preferably equal to or greater than 0.30% by mass and equal to or less than 0.80% by mass and further preferably equal to or greater than 0.40% by mass and equal to or less than 0.70% by mass.

In order to provide the toner which has excellent fixability, can be charged to the desired charge amount and can form images with the desired density and a small amount of fog even when images are continuously formed under various environments, the content of the carbon nanotube is preferably equal to or greater than 0.10 parts by mass and equal to or less than 1.20 parts by mass relative to the 100.00 parts by mass of the binding resin, more preferably equal to or greater than 0.12 parts by mass and equal to or less than 1.00 part by mass and further preferably equal to or greater than 0.40 parts by mass and equal to or less than 0.80 parts by mass.

The carbon nanotube is preferably a single-walled carbon nanotube or a multi-walled carbon nanotube. The single-walled carbon nanotube has a single cylindrical structure. The multi-walled carbon nanotube has a structure in which a plurality of (for example, two or more) cylinders having different diameters are nested together.

The inside diameter of the carbon nanotube is preferably equal to or greater than 5 nm and equal to or less than 50 nm, and more preferably equal to or greater than 7 nm and equal to or less than 40 nm. The length of the carbon nanotube is preferably equal to or greater than 1 μm and equal to or less than 10 μm. However, in a toner core formation step when the toner is manufactured, kneading and pulverizing are performed, and thus carbon nanotubes are cut to some extent, with the result that a carbon nanotube having a length exceeding 10 μm can also be used. The carbon nanotube can be confirmed by observing the cross section of the toner particle using a transmission electron microscope (TEM).

### (Colorant)

The toner in the present disclosure is generally black because it contains magnetic powder. Hence, the toner may contain a black colorant in order to adjust an image formed using the toner in the present disclosure to a more desirable black hue as long as the object of the present disclosure is not impeded. Examples of the black colorant include carbon black and aniline black. The carbon black is classified into, for example, furnace black, acetylene black, lamp black and channel black depending on the manufacturing method. The furnace black is manufactured by a furnace method. The acetylene black is manufactured by an acetylene method. The lamp black is manufactured by a lamp smoke method. The channel black is manufactured by a channel method.

The black colorant is preferably the carbon black, and more preferably the furnace black or the acetylene black. The furnace black is easy to mass-produce with high yield and is relatively inexpensive. Hence, the furnace black is used as the black colorant, and thus cost benefits can be increased in the manufacturing of the toner. On the other hand, the acetylene black has high electrical conductivity, and functions as a conductive additive. Therefore, a combination of the carbon nanotube having high electrical conductivity and the acetylene black having high electrical conductivity is used, and thus it is possible to appropriately charge the toner to the desired charge amount even when images are formed continuously under various environments.

It is also possible to use a masterbatch in which the black colorant is dispersed in advance in a resin such as the thermoplastic resin. When the masterbatch of the black colorant is used, the resin included in the masterbatch is preferably the same resin as the binding resin.

The number average primary particle diameter of the black colorant is preferably equal to or greater than 1 nm and equal to or less than 50 nm, and more preferably equal to or greater than 20 nm and equal to or less than 30 nm. The nitrogen adsorption specific surface area of the black colorant is preferably equal to or greater than 50 m²/g and equal to or less than 200 m²/g, and more preferably equal to or greater than 110 m²/g and equal to or less than 140 m²/g. The DBP absorption amount of the black colorant is preferably equal to or greater than 50 cm³/100 g and equal to or less than 200 cm³/100 g, and more preferably equal to or greater than 90 cm³/100 g and equal to or less than 110 cm³/100 g.

The content of the black colorant is preferably equal to or greater than 4% by mass and equal to or less than 10% by mass relative to the mass of the toner core, and more preferably equal to or greater than 5% by mass and equal to or less than 9% by mass.

The black colorant can be confirmed by observing the cross section of the toner particle using a transmission electron microscope (TEM). In order to achieve a desired color tone, a colorant other than black may be further contained in the toner core.

In order to achieve a desired color tone, the ratio of the mass of the carbon nanotube to the mass of the black colorant is preferably equal to or greater than 0.010 and equal to or less than 0.150, more preferably equal to or greater than 0.020 and equal to or less than 0.120 and further preferably equal to or greater than 0.050 and equal to or less than 0.100.

### (Mold Release Agent)

In order to enhance fixability and offset resistance, the toner core preferably contains a mold release agent. Although the mold release agent is not particularly limited, wax is preferable in terms of more efficiently suppressing the occurrence of offset and image smearing (that is, a stain around an image when the image is rubbed). Examples of the wax include carnauba wax, synthetic ester wax, polyethylene wax, polypropylene wax, fluororesin-based wax, Fischer-Tropsch wax, paraffin wax, montan wax and rice wax.

When the polyester resin is used as the binding resin, in terms of compatibility, one or more mold release agents selected from the group consisting of carnauba wax, synthetic ester wax and polyethylene wax are preferably used as the mold release agent.

When the polystyrene resin is used as the binding resin, also in terms of compatibility, one or more mold release agents selected from the group consisting of Fischer-Tropsch wax and paraffin wax are preferably used as the mold release agent. The Fischer-Tropsch wax is a linear hydrocarbon compound with few isostructural molecules and side chains. The Fischer-Tropsch wax is manufactured utilizing a Fischer-Tropsch reaction which is a catalytic hydrogenation reaction of carbon monoxide.

As the Fischer-Tropsch wax, a Fischer-Tropsch wax is preferable in which the mass average molecular weight is equal to or greater than 1,000, and the bottom temperature of an endothermic peak observed by a DSC measurement is equal to or greater than 100° C. and equal to or less than 120° C. Examples of the Fischer-Tropsch wax as described above include Sasolwax C1 (bottom temperature of an endothermic peak: 106.5° C.), Sasolwax C105 (bottom temperature of an endothermic peak: 102.1° C.), and Sasolwax SPRAY (bottom temperature of an endothermic peak: 102.1° C.) which are available from Sasol.

The content of the mold release agent is preferably equal to or greater than 1% by mass and equal to or less than 10% by mass relative to the mass of the toner core. As the content of the mold release agent is higher, it is possible to effectively suppress the occurrence of offset and image smearing in the formed image. On the other hand, when the content of the mold release agent is lower, toner particles are unlikely to fuse together, and thus the heat resistant storability of the toner is enhanced.

### (Charge Control Agent)

In order to enhance the charge level and the charge rise characteristic of the toner and to obtain the toner excellent in durability and stability, the toner core preferably contains a charge control agent. The charge rise characteristic of the toner serves as an index of whether the toner can be charged to a predetermined charge level in a short period of time. When the toner is positively charged, and development is performed, a positively charging charge control agent is used. On the other hand, when the toner is negatively charged, and development is performed, a negatively charging charge control agent is used.

Examples of the positively charging charge control agent include an azine compound, a direct dye, a nigrosine compound, an acid dye, a metal salt of naphthenic acid, a metal salt of higher fatty acid, alkoxylated amine, alkylamide and a quaternary ammonium salt compound. Examples of the azine compound include pyridazine, pyrimidine, pyrazine, 1,2-oxazine, 1,3-oxazine, 1,4-oxazine, 1,2-thiazine, 1,3-thiazine, 1,4-thiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline and quinoxaline. Examples of the direct dye include Azine Fast Red FC, Azine Fast Red 12BK, Azine Violet BO, Azine Brown 3G, Azine Light Brown GR, Azine Dark Green BH/C, Azine Deep Black EW and Azine Deep Black 3RL. Examples of the nigrosine compound include nigrosine, nigrosine salt and nigrosine derivative. Examples of the acid dye include Nigrosine BK, Nigrosine NB and Nigrosine Z. Examples of the quaternary ammonium salt compound include benzyldecylhexylmethylammonium chloride and decyltrimethylammonium chloride. Among these positively charging charge control agents, the quaternary ammonium salt compound is preferable in that the quaternary ammonium salt compound provides a more rapid charge rise characteristic.

A resin which has a quaternary ammonium salt, a carboxylate or a carboxy group as a functional group can also be used as the positively charging charge control agent. More specifically, examples thereof include a styrene resin having a quaternary ammonium salt, an acrylic resin having a quaternary ammonium salt, a styrene-acrylic resin having a quaternary ammonium salt, a polyester resin having a quaternary ammonium salt, a styrene resin having a carboxylate, an acrylic resin having a carboxylate, a styrene-acrylic resin having a carboxylate, a polyester resin having a carboxylate, a styrene resin having a carboxy group, an acrylic resin having a carboxy group, a styrene-acrylic resin having a carboxy group and a polyester resin having a carboxy group. The molecular weights of these resins are not particularly limited, and they may be oligomers or polymers.

Among the resins which can be used as the positively charging charge control agent, a styrene-acrylic resin having a quaternary ammonium salt as a functional group is more preferable in that the charge amount can be easily adjusted to a value in a desired range. In the styrene-acrylic resin having a quaternary ammonium salt as a functional group, an example of an acrylic acid-based monomer copolymerizable with styrene is (meth)acrylic acid alkyl ester. Examples of the (meth)acrylic acid alkyl ester include methyl acrylate, ethyl acrylate, n-propyl acrylate, iso-propyl acrylate, n-butyl acrylate, iso-butyl acrylate, 2-ethylhexyl acrylate, methyl methacrylate, ethyl methacrylate, n-butyl methacrylate and iso-butyl methacrylate.

Examples of a quaternary ammonium salt monomer which can be used for copolymerization of the styrene-acrylic resin having a quaternary ammonium salt as a functional group include monomers derived from dialkylaminoalkyl(meth)acrylate, dialkyl(meth)acrylamide and dialkylaminoalkyl(meth)acrylamide through a quaternization process. Examples of the dialkylaminoalkyl(meth)acrylate include dimethylaminoethyl (meth)acrylate, diethylaminoethyl (meth)acrylate, dipropylaminoethyl (meth)acrylate and dibutylaminoethyl (meth)acrylate. Examples of the dialkyl(meth)acrylamide include dimethyl methacrylamide. Examples of the dialkylaminoalkyl(meth)acrylamide include dimethylaminopropyl methacrylamide. A hydroxy group-containing polymerizable monomer (more specifically, hydroxyethyl (meth)acrylate, hydroxypropyl (meth)acrylate, 2-hydroxybutyl (meth)acrylate, N-methylol (meth)acrylamide or the like) can also be used together during polymerization.

Examples of the negatively charging charge control agent include an organic metal complex, a chelate compound, a monoazo metal complex, an acetylacetone metal complex, an aromatic hydroxycarboxylic acid, an aromatic dicarboxylic acid metal complex, aromatic monocarboxylic acid, aromatic polycarboxylic acid and a phenol derivative (more specifically, bisphenol or the like). Each of the aromatic monocarboxylic acid and the aromatic polycarboxylic acid may be a metal salt, an anhydride or an ester derivative thereof. Among them, the organic metal complex and the chelate compound are preferable. As the organic metal complex and the chelate compound, an acetylacetone metal complex (more specifically, aluminum acetylacetonate, iron (II) acetylacetonate or the like), a salicylic acid metal complex (more specifically, 3,5-di-tert-butylsalicylic acid chromium or the like) and a salicylic acid metal salt are more preferable.

The content of the charge control agent is preferably equal to or greater than 0.1% by mass and equal to or less than 10% by mass relative to the mass of the toner core. As the content of the charge control agent is higher, the toner is easily and stably charged to a predetermined polarity, and it is easy to obtain an image with the desired density. As the content of the charge control agent is higher, the charge control agent is easily and uniformly dispersed, and thus fog is unlikely to occur in the formed image, with the result that it is possible to effectively suppress contamination of an image carrying member caused by a toner component. On the other hand, as the content of the charge control agent is lower, sufficient chargeability is easily ensured even under high temperature and high humidity conditions.

### (Magnetic Particle)

Although the magnetic particle is not particularly limited, examples thereof include irons (more specifically, ferrite, magnetite and the like), ferromagnetic metals (more specifically, cobalt, nickel and the like), an alloy containing iron and/or a ferromagnetic metal, a compound containing iron and/or a ferromagnetic metal, a ferromagnetic alloy which has been subjected to ferromagnetic treatment (more specifically, heat treatment or the like) and chromium dioxide.

Although the particle diameter of the magnetic particle is not particularly limited, the particle diameter is preferably equal to or greater than 0.1 μm and equal to or less than 1.0 μm, and more preferably equal to or greater than 0.1 μm and equal to or less than 0.5 μm. When the magnetic particle having a particle diameter in such a range is used, the magnetic particle is easily and uniformly dispersed in the binding resin.

In order to improve dispersibility in the binding resin, a magnetic particle may be used which has been surface-treated with a surface treatment agent (more specifically, a titanium coupling agent, a silane coupling agent or the like).

When the magnetic particle is contained in the toner core, the content of the magnetic particle needs to be equal to or greater than 30.0% by mass and equal to or less than 50.0% by mass relative to the mass of the toner core, and is more preferably equal to or greater than 35.0% by mass and equal to or less than 45.0% by mass. As the content of the magnetic particle is lower, the fixability of the toner is easily enhanced, and thus images with the desired density are easily formed when images are continuously formed for a long period of time. On the other hand, when the content of the magnetic particle is higher, fog is unlikely to occur in the formed image, and thus it is possible to suppress a decrease in the image density when images are continuously formed for a long period of time.

### <Shell Layer>

The shell layer is formed of, for example, resin particles. In the following description, the “resin particle which forms the shell layer” may be referred to as the “shell resin particle”.

### <Shell Resin Particle>

The shell resin particle contains a resin. In the following description, the “resin contained in the shell resin particle” may be referred to as the “shell resin”. The content of the shell resin in the shell resin particle is preferably equal to or greater than 90% by mass, more preferably equal to or greater than 95% by mass and particularly preferably substantially 100% by mass.

The shell resin is preferably a charge control resin. The shell layer is formed of the charge control resin, and thus even when images are continuously formed under various environments such as a normal temperature and normal humidity environment, a high temperature and high humidity environment and a low temperature and low humidity environment, the toner can be charged to the desired charge amount. Consequently, images of the desired density can be suitably formed under various environments.

Since the shell layer having a predetermined structure is easily formed, the shell resin is preferably a polymer of a monomer having an unsaturated bond. When the shell resin is the charge control resin, the charge control resin is preferably a copolymer of a monomer which has a charged functional group charging the shell resin and an unsaturated bond and a monomer which does not have a charged functional group but has an unsaturated bond.

When the shell resin is positively charged, examples of a positive charged functional group include a nitrogen-containing polar functional group such as quaternary ammonium group. On the other hand, when the shell resin is negatively charged, examples of a negative charged functional group include a fluorine-substituted hydrocarbon group and a sulfo group.

The monomer having an unsaturated bond is not particularly limited as long as it is possible to synthesize a resin which has sufficient physical properties as the shell layer. As the monomer having an unsaturated bond, a vinyl monomer is preferable. The α-position of the vinyl group included in the vinyl monomer may be substituted with an alkyl group. The alkyl group which may be included in the vinyl group is preferably an alkyl group having 1 to 6 carbon atoms, more preferably a methyl group or an ethyl group and particularly preferably a methyl group. The vinyl group included in the vinyl monomer may be substituted with a halogen atom. The halogen atom which may be included in the vinyl group is preferably a chlorine atom or a bromine atom, and more preferably a chlorine atom.

The monomer which does not have a charged functional group but has an unsaturated bond is preferably a vinyl monomer which does not have a charged functional group. The monomer which has a charged functional group and an unsaturated bond is preferably a vinyl monomer which has a charged functional group. When the shell resin is positively charged, the vinyl monomer having a charged functional group is preferably a vinyl monomer which has a positive charged functional group. When the shell resin is negatively charged, the vinyl monomer having a charged functional group is preferably a vinyl monomer which has a negative charged functional group.

Examples of the vinyl monomer which does not have a charged functional group include styrene, styrene derivatives (more specifically, o-methylstyrene, m-methylstyrene, p-methylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, p-ethoxystyrene, p-phenylstyrene, p-chlorostyrene, 3,4-dichlorostyrene and the like), ethylenically unsaturated monoolefins (more specifically, ethylene, propylene, butylene, isobutylene, and the like), vinyl halides (more specifically, vinyl chloride, vinylidene chloride, vinyl bromide, vinyl fluoride and the like), vinyl esters (more specifically, vinyl acetate, vinyl propionate, vinyl benzoate, vinyl butyrate and the like), (meth)acrylic acid esters (more specifically, methyl (meth)acrylate, ethyl (meth)acrylate, n-butyl (meth)acrylate, isobutyl (meth)acrylate, propyl (meth)acrylate, n-octyl (meth)acrylate, dodecyl (meth)acrylate, 2-ethylhexyl (meth)acrylate, stearyl (meth)acrylate, 2-chloroethyl (meth)acrylate, phenyl (meth)acrylate, methyl α-chloroacrylate and the like), acrylonitrile, vinyl ethers (more specifically, vinyl methyl ether, vinyl ethyl ether, vinyl isobutyl ether and the like), vinyl ketones (more specifically, vinyl methyl ketone, vinyl hexyl ketone, methyl isopropenyl ketone and the like) and vinyl naphthalene. Among them, styrene and the (meth)acrylic acid ester are preferable. As the (meth)acrylic acid ester, (meth)acrylic acid alkyl ester is preferable, butyl (meth)acrylate is more preferable and n-butyl (meth)acrylate is further preferable.

Examples of the vinyl monomer having a positive charged functional group include an N-vinyl compound, an aminoacrylic acid-based monomer, (meth)acrylonitrile and (meth)acrylamide.

Examples of the N-vinyl compound include N-vinylpyrrole, N-vinylcarbazole, N-vinylindole and N-vinylpyrrolidone.

Examples of the aminoacrylic acid-based monomer include compounds represented by formula (1) “CH₂═C(R₁)—(CO)—X—N(R₂)(R₃)”. In formula (1), R₁ represents hydrogen or a methyl group. In formula (1), each of R₂ and R₃ represents a hydrogen atom or an alkyl group having 1 to 20 carbon atoms. X represents —O—, —O-Q- or —NH. Q represents an alkylene group having 1 to 10 carbon atoms, a phenylene group or a combination of these groups.

In formula (1), examples of the alkyl group represented by each of R₂ and R₃ and having 1 to 20 carbon atoms include a methyl group, an ethyl group, an n-propyl group, an isopropyl group, an n-butyl group, an isobutyl group, a sec-butyl group, a tert-butyl group, an n-pentyl group, an isopentyl group, a tert-pentyl group, an n-hexyl group, an n-heptyl group, an n-octyl group, a 2-ethylhexyl group, an n-nonyl group, an n-decyl group, an n-undecyl group, an n-dodecyl group (lauryl group), an n-tridecyl group, an n-tetradecyl group, an n-pentadecyl group, an n-hexadecyl group, an n-heptadecyl group, an n-octadecyl group (stearyl group), an n-nonadecyl group and an n-icosyl group.

In formula (1), examples of the alkylene group represented by Q and having 1 to 10 carbon atoms include a methylene group, a 1,2-ethane-diyl group, a 1,1-ethylene group, a propane-1,3-diyl group, a propane-2,2-diyl group, a propane-1,1-diyl group, a propane-1,2-diyl group, a butane-1,4-diyl group, a pentane-1,5-diyl group, a hexane-1,6-diyl group, a heptane-1,7-diyl group, an octane-1,8-diyl group, a nonane-1,9-diyl group and a decane-1,10-diyl group. In formula (1), examples of the phenylene group represented by Q include a p-phenylene group, an m-phenylene group, an o-phenylene group and a divalent group obtained by removing a hydrogen atom from the 4-position of a phenyl group included in a benzyl group.

Examples of the aminoacrylic acid-based monomer represented by formula (1) include N,N-dimethylamino(meth)acrylate, N,N-dimethylaminomethyl(meth)acrylate, N,N-diethylaminomethyl(meth)acrylate, 2-(N,N-methylamino)ethyl(meth)acrylate, 2-(N,N-diethylamino)ethyl(meth)acrylate, 3-(N,N-dimethylamino) propyl(meth)acrylate, 4-(N,N-dimethylamino)butyl(meth)acrylate, p-N,N-dimethylaminophenyl(meth)acrylate, p-N,N-diethylaminophenyl(meth)acrylate, p-N,N-dipropylaminophenyl(meth)acrylate, p-N,N-di-n-butylaminophenyl(meth)acrylate, p-N-laurylaminophenyl(meth)acrylate, p-N-stearylaminophenyl(meth)acrylate, (p-N,N-dimethylaminophenyl)methyl (meth)acrylate, (p-N,N-diethylaminophenyl)methyl(meth)acrylate, (p-N,N-di-n-propylaminophenyl)methyl(meth)acrylate, (p-N,N-di-n-butylaminophenyl)methylbenzyl(meth)acrylate, (p-N-laurylaminophenyl)methyl (meth)acrylate, (p-N-stearylaminophenyl)methyl(meth)acrylate, N,N-dimethylaminoethyl(meth)acrylamide, N,N-diethylaminoethyl(meth)acrylamide, 3-(N,N-dimethylamino) propyl(meth)acrylamide, 3-(N,N-diethylamino) propyl(meth)acrylamide, p-N,N-dimethylaminophenyl(meth)acrylamide, p-N,N-diethylaminophenyl(meth)acrylamide, p-N,N-di-n-propylaminophenyl(meth)acrylamide, p-N,N-di-n-butylaminophenyl(meth)acrylamide, p-N-laurylaminophenyl(meth)acrylamide, p-N-stearylaminophenyl(meth)acrylamide, (p-N,N-dimethylaminophenyl)methyl(meth)acrylamide, (p-N,N-diethylaminophenyl)methyl(meth)acrylamide, (p-N,N-di-n-propylaminophenyl)methyl(meth)acrylamide, (p-N,N-di-n-butylaminophenyl)methyl(meth)acrylamide, (p-N-laurylaminophenyl)methyl(meth)acrylamide and (p-N-stearylaminophenyl)methyl(meth)acrylamide. As the aminoacrylic acid-based monomer represented by formula (1), 2-(N,N-diethylamino)ethyl (meth)acrylate is preferable, and 2-(N,N-diethylamino)methacrylate is more preferable.

Examples of the negative charged functional group include a fluorine-substituted hydrocarbon group and a sulfo group. Examples of the vinyl monomer having a negative charged functional group include a vinyl monomer having a fluorine-substituted hydrocarbon group and a vinyl monomer having a sulfo group. Examples of the vinyl monomer having a fluorine-substituted hydrocarbon group include fluoroalkyl(meth)acrylates (more specifically, 2,2,2-trifluoroethyl acrylate, 2,2,3,3-tetrafluoropropyl acrylate, 2,2,3,3,4,4,5,5-octafluoroamyl acrylate, 1H, 1H,2H,2H-heptadecafluorodecyl acrylate and the like), trifluorochloroethylene, vinylidene fluoride, ethylene trifluoride, ethylene tetrafluoride, trifluoropropylene, hexafluoropropene and hexafluoropropylene. Examples of the vinyl monomer having a sulfo group include 2-acrylamido-2-methylpropanesulfonic acid, sodium styrenesulfonate and sulfoalkyl(meth)acrylic acids (more specifically, sulfoethylacrylic acid, sulfoethylmethacrylic acid, sodium sulfoethylmethacrylate and the like).

A method for addition polymerization of the monomer having an unsaturated bond is not particularly limited, and any method such as solution polymerization, bulk polymerization, emulsion polymerization or suspension polymerization can be selected.

Examples of a polymerization initiator which can be used for addition polymerization of the vinyl monomer include potassium persulfate, sodium peroxodisulfate, potassium peroxodisulfate, ammonium peroxodisulfate, acetyl peroxide, decanoyl peroxide, lauroyl peroxide, benzoyl peroxide, azobisisobutyronitrile, azobismethylbutyronitrile, 2,2′-azobis-2,4-dimethylvaleronitrile, 2,2′-azobis-4-methoxy-2,4-dimethylvaleronitrile, t-butylperoxy-2-ethylhexanoate, t-butylperbenzoate, dicyclohexyl peroxide and dicumyl peroxide. The amount of polymerization initiator used is preferably equal to or greater than 0.1% by mass and equal to or less than 15% by mass relative to the total mass of the monomer.

When as in emulsion polymerization or suspension polymerization, a monomer having an unsaturated bond is subjected to addition polymerization using an aqueous medium, a surfactant can be used. The surfactant is not particularly limited, and can be appropriately selected from the group consisting of an anionic surfactant, a cationic surfactant and a nonionic surfactant. Examples of the anionic surfactant include a sulfate ester salt surfactant, a sulfonate salt surfactant, a phosphate ester salt surfactant and soap. Examples of the cationic surfactant include an amine salt surfactant and a quaternary ammonium salt surfactant. Examples of the nonionic surfactant include a polyethylene glycol surfactant, an alkylphenol ethylene oxide adduct surfactant and polyhydric alcohol surfactants (more specifically, glycerin, sorbitol, sorbitan and the like).

When the charge control resin is a copolymer of a monomer which has a charged functional group and an unsaturated bond and a monomer which does not have a charged functional group but has an unsaturated bond, the content of a repeating unit derived from the monomer having a charged functional group and an unsaturated bond in all the repeating units of the charge control resin is preferably equal to or greater than 0.1 mol % and equal to or less than 10 mol %, and more preferably equal to or greater than 0.3 mol % and equal to or less than 7 mol %.

The content of the charge control resin in the shell resin is preferably equal to or greater than 80% by mass, more preferably equal to or greater than 90% by mass and particularly preferably substantially 100% by mass.

The shell layer may be formed using a mixture of the charge control resin and a resin which is not the charge control resin (resin which does not have a charged functional group). As the resin which is not the charge control resin, at least one polymer of a vinyl monomer which does not have a charged functional group can be used. Examples of a method for mixing the charge control resin with the resin which is not the charge control resin include a method of melt-kneading these resins using a melt-kneading device such as a twin-screw extruder and a method of dissolving these resins in an organic solvent and removing the organic solvent from the resulting resin solution.

The shell layer may be formed by using the shell resin particle containing the charge control resin and the shell resin particle containing the resin which is not the charge control resin. In this case, the ratio of the mass of the shell resin particle containing the charge control resin to the total mass of the shell resin particle used for the formation of the shell layer is preferably equal to or greater than 80% by mass, and more preferably equal to or greater than 90% by mass.

The glass transition point of the shell resin is preferably equal to or greater than 45° C. and equal to or less than 90° C., and more preferably equal to or greater than 50° C. and equal to or less than 80° C. The softening point of the shell resin is preferably equal to or greater than 100° C. and equal to or less than 250° C., and more preferably equal to or greater than 110° C. and equal to or less than 240° C. The softening point of the shell resin is preferably higher than the softening point of the binding resin contained in the toner core, and more preferably higher than the softening point of the binding resin by 10° C. or more and 140° C. or less. The temperature characteristics of the shell resin are caused to fall within these ranges, and thus when the shell resin particle is embedded in the toner core, a part of the shell resin particle which makes contact with the toner core is unlikely to be deformed, with the result that a projection derived from the shape of the shell resin particle before being changed into the shell layer is easily formed in the inner surface of the shell layer.

The mass average molecular weight (Mw) of the shell resin is preferably equal to or greater than 20,000 and less than 1,500,000.

The number average primary particle diameter of the shell resin particle is preferably equal to or greater than 0.03 μm and equal to or less than 1 μm, more preferably equal to or greater than 0.04 μm and equal to or less than 0.7 μm, particularly preferably equal to or greater than 0.05 μm and equal to or less than 0.5 μm and most preferably equal to or greater than 0.05 μm and equal to or less than 0.3 μm. When the shell resin particle having the number average primary particle diameter described above is used, the surface of the toner core is easily and uniformly covered with a single layer of the shell resin particle, and thus the shell layer of a desired structure is easily formed. When the number average primary particle diameter of the shell resin particle is larger, the shell layer having a sufficient thickness is easily formed on the surface of the toner core, and thus the heat resistant storability of the toner is enhanced. On the other hand, when the number average primary particle diameter of the shell resin particle is smaller, the shell resin particle is easily and uniformly adhered to the surface of the toner core. Hence, the shell layer of a predetermined structure is easily formed. The number average primary particle diameter of the shell resin particle can be adjusted, for example, by appropriately changing at least one of polymerization conditions, a pulverization method and a classification method.

The content of the shell resin particle is preferably equal to or greater than 1 part by mass and equal to or less than 20 parts by mass relative to the 100 parts by mass of the toner core, and more preferably equal to or greater than 3 parts by mass and equal to or less than 15 parts by mass. When the content of the shell resin particle is higher, the entire surface of the toner core is easily covered by the shell resin particle. The entire surface of the toner core is covered by the shell resin particle, the toner is unlikely to aggregate when stored at high temperature, and thus the heat resistant storability is easily enhanced. When the content of the shell resin particle is lower, the thickness of the shell layer is reduced, and thus the toner excellent in fixability is easily obtained.

### <External Additive>

The external additive is not particularly limited, and can be appropriately selected from known external additives used for toners. Examples of the external additive include silica and metal oxides (more specifically, alumina, titanium oxide, magnesium oxide, zinc oxide, strontium titanate, barium titanate and the like). As already described, the toner particle preferably prevents from including the carbon nanotube as the external additive. The surface of the external additive particles may be subjected to either or both of positive charging treatment and hydrophobic treatment. The number average primary particle diameter of the external additive particles is preferably equal to or greater than 0.01 μm and equal to or less than 1.0 μm.

The content of the external additive is preferably equal to or greater than 0.1 parts by mass and equal to or less than 10.0 parts by mass relative to 100.0 parts by mass of the toner base particle, and more preferably equal to or greater than 0.2 parts by mass and equal to or less than 5.0 parts by mass. When the content of the external additive is higher, the hydrophobicity of the toner is easily enhanced. Consequently, the toner is unlikely to be affected by water molecules in the air in a high temperature and high humidity environment, and thus sufficient chargeability of the toner can be ensured, with the result that images of the desired density can be formed. The flowability of the toner can also be enhanced. When the content of the external additive is lower, it is possible to suppress a decrease in the image density caused by charging up the toner.

### <Method for Manufacturing Toner>

The toner in the present embodiment can be manufactured by performing, for example, a toner core formation step, a shell layer formation step and an external addition step. When the non-encapsulated toner particle is manufactured, the shell layer formation step can be omitted. When the toner particle does not include the external additive, the external addition step can be omitted.

### <Toner Core Formation Step>

In the toner core formation step, the binding resin, the magnetic particle, the carbon nanotube and any internal additive are mixed with a mixing device or the like, and thus a mixture is obtained. The mixture is melt-kneaded with a kneading device such as a single-screw or twin-screw extruder, and thus a kneaded product is obtained. The kneaded product is pulverized, and thus a pulverized product is obtained. When the diameter of the pulverized product needs to be reduced, the pulverized product is further finely pulverized. When the uniform particle diameter of the pulverized product needs to be achieved, the pulverized product is classified. By the method described above, the toner core which is the pulverized product is obtained.

### (Shell Layer Formation Step)

In the shell layer formation step, the shell resin particles are used to form the shell layer. The shell resin particles are, for example, spherical. A mixing device or the like is used to mix the toner core and the shell resin particles, and thus the shell resin particles are adhered to the surface of the toner core. By the adhesion, the shell layer formed of the shell resin particles is formed on the surface of the toner core. In order to form a thin and uniform shell layer, it is preferable to adhere the shell resin particles to the surface of the toner core so that the shell resin particles do not overlap each other in a direction perpendicular to the surface of the toner core.

In order to adjust the smoothness of the shell layer, a mechanical external force may be applied to the outer surface of the shell resin particles adhered to the surface of the toner core such that the shell resin particles are deformed. As the mechanical external force is increased, the degree of the smoothness of the outer surface of the shell layer is increased. An example of a method for applying the mechanical external force is a method of applying an impact force to the toner base particles by collision of the toner base particles when the toner cores (that is, the toner base particles) to which the external additive is adhered move at high speed in a narrow space in a mixing device. Another example of the method for applying the mechanical external force is a method of applying an impact force to the toner base particles by collision of the toner base particles with the inner walls, the rotor or the stator of a mixing device when the toner cores (that is, the toner base particles) to which the external additive is adhered move at high speed in a narrow space in the mixing device.

### (External Addition Step)

In the external addition step, the external additive is adhered to the surface of the toner base particles, and thus the toner particles are obtained. An example of a method for adhering the external additive to the surface of the toner base particles is a method of stirring the toner base particles and the external additive with a mixing device (more specifically, an FM mixer, a Nauta mixer (registered trademark) or the like). It is preferable to adjust treatment conditions so that the external additive particles are not embedded in the toner base particles.

### EXAMPLES

The present disclosure will be more specifically described below using Examples. However, the present disclosure is not limited to Examples at all.

### [Synthesis of Binding Resin]

A polyester resin (BR1) used as the binding resin in the toner core formation step was synthesized by the following method. 1960 g of a propylene oxide adduct of bisphenol A, 780 g of an ethylene oxide adduct of bisphenol A, 257 g of dodecenyl succinic anhydride, 770 g of terephthalic acid and 4 g of dibutyltin oxide were placed into a reaction container. The reaction container was filled with nitrogen gas, and the temperature inside the reaction container was increased to 235° C. while the reaction container was being stirred. Then, the reaction was performed at the same temperature for 8 hours, and thereafter, the pressure inside the reaction container was reduced to 8.3 kPa and the reaction was performed for 1 hour. Thereafter, the reaction mixture was cooled to 180° C., and trimellitic anhydride was added into the reaction container such that the acid value was 7 mg KOH/g. Then, the temperature of the reaction mixture was increased to 210° C. at a rate of 10° C./hour, and the reaction was performed at the same temperature. After the reaction was completed, the contents of the reaction container were taken out and cooled, and thus the polyester resin (BR1) was obtained.

### [Carbon Nanotube]

The commercially available carbon nanotubes used in the toner core formation step are listed below.
Carbon nanotube (CN-A): single-walled carbon nanotube (“ZEONANO (registered trademark) SG101” made by ZEON Corporation)
Carbon nanotube (CN-B): single-walled carbon nanotube (“SWNTSO” made by Meijo Nano Carbon Co., Ltd.)
Carbon nanotube (CN-C): Multi-walled carbon nanotube (“MWNT” made by Meijo Nano Carbon Co., Ltd.)

### [Synthesis of Resin Particle]

A resin particle (A) used in the shell layer formation step was synthesized by the following method. A flask which included a stirring device, a thermometer, a cooling tube and a nitrogen inlet tube was used as a reaction container. 180 g of isobutanol serving as a solvent was placed into the reaction container. 16 g of diethylaminoethyl methacrylate and 16 g of methyl paratoluenesulfonate were further added into the reaction container. The reaction container was placed on a mantle heater, and nitrogen gas was introduced into the reaction container through the nitrogen inlet tube to create an inert atmosphere inside the reaction container. Then, while the contents of the reaction container were being stirred at a stirring rate of 100 rpm, the internal temperature of the reaction container was increased to 80° C. The contents of the reaction container were continuously stirred at a stirring rate of 100 rpm at the same temperature for 1 hour, and thus a quaternization reaction was performed. After the quaternization reaction, 214 g of styrene, 72 g of butyl acrylate and 12 g of t-butylperoxy-2-ethylhexanoate serving as a peroxide initiator (made by ARKEMA Yoshitomi, Ltd.) were added into the reaction container. The internal temperature of the reaction container was increased to 95° C. (polymerization temperature), and then the contents of the reaction container were stirred at a stirring rate of 100 rpm for 3 hours. Then, 6 g of t-butylperoxy-2-ethylhexanoate was further added into the reaction container. Thereafter, the contents of the reaction container were stirred at 95° C. for 3 hours at a stirring rate of 100 rpm, and thus the polymerization reaction was completed. In this way, a resin particle dispersion liquid was obtained. The resulting resin particle dispersion liquid was freeze-dried, and thus the powdered resin particle (A) was obtained. The number average primary particle diameter of the resin particle (A) was 0.10 μm.

### [Manufacturing of Toner]

Toners shown in Tables 1 to 3 below were manufactured by the following method.

TABLE 1

| | | Example1 | Example2 | Example3 | Example4 | Example5 |
|---|---|---|---|---|---|---|
| Toner | | T-A1 | T-A2 | T-A3 | T-A4 | T-A5 |
| BK | Type | BK-a | BK-a | BK-a | BK-a | BK-a |
| | Amount (parts) | 40 | 40 | 40 | 40 | 40 |
| CN | Type | CN-A | CN-A | CN-A | CN-B | CN-C |
| | Amount (parts) | 0.5 | 0.1 | 1 | 0.5 | 0.5 |

| | | | | | |
|---|---|---|---|---|---|
| Shell layer | Not present | Not present | Not present | Not present | Not present |
| BK content [%] | 40 | 40 | 40 | 40 | 40 |
| CN content [%] | 0.49 | 0.1 | 0.97 | 0.49 | 0.49 |

TABLE 2

| | | Example6 | Example7 | Example8 | Example9 |
|---|---|---|---|---|---|
| Toner | | T-A6 | T-A7 | T-A8 | T-A9 |
| BK | Type | BK-a | BK-a | BK-b | BK-a |
| | Amount | 30 | 50 | 40 | 40 |
| | (parts) | | | | |
| CN | Type | CN-A | CN-A | CN-A | CN-A |
| | Amount | 0.5 | 0.5 | 0.5 | 0.5 |
| | (parts) | | | | |

| | | | | |
|---|---|---|---|---|
| Shell layer | Not present | Not present | Not present | Present |
| BK content [%] | 30 | 50 | 40 | 40 |
| CN content [%] | 0.49 | 0.49 | 0.49 | 0.49 |

TABLE 3

| | | Comparative | Comparative | Comparative | Comparative | Comparative |
|---|---|---|---|---|---|---|
| | | example1 | example2 | example3 | example4 | example5 |
| Toner | | T-B1 | T-B2 | T-B3 | T-B4 | T-B5 |
| BK | Type | BK-a | BK-a | BK-a | BK-a | BK-a |
| | Amount (parts) | 40 | 40 | 25 | 55 | 40 |
| CN | Type | CN-A | CN-A | CN-A | CN-A | — |
| | Amount (parts) | 0.05 | 1.1 | 0.5 | 0.5 | — |

| | | | | | |
|---|---|---|---|---|---|
| Shell layer | Not present | Not present | Not present | Not present | Not present |
| BK content [%] | 40 | 40 | 25 | 55 | 40 |
| CN content [%] | 0.05 | 1.1 | 0.49 | 0.49 | — |

The abbreviations used in Tables 1 to 3 are shown below.
BK: magnetic particle
CN: carbon nanotube
parts: parts by mass
%: % by mass
-: corresponding component was not added or corresponding value was not provided
BK content: the content of magnetic particles in a toner core (specifically, the content calculated from a formula “content of magnetic particles in toner core=100×amount of magnetic particles added/mass of toner core=100×amount of magnetic particles added/(amount of binding resin added+amount of release agent added+amount of charge control agent added+amount of magnetic particles added+amount of carbon nanotube added)”
CN content: the content of carbon nanotube in a toner core (specifically, the content calculated from a formula “content of carbon nanotube in toner core=100×amount of carbon nanotube added/mass of toner core=100×amount of carbon nanotube added/(amount of binding resin added+amount of release agent added+amount of charge control agent added+amount of magnetic particles added+amount of carbon nanotube added)”

### <Manufacturing of Toner (T-A1)

### (Toner Core Formation Step)

A mixture was obtained by mixing, with a mixing device, 53.50 parts by mass of the polyester resin (BR1) serving as the binding resin, 5.00 parts by mass of a release agent (polypropylene wax, “VISCOL (registered trademark) 660-P” made by Sanyo Chemical Industries, Ltd.), 1.00 part by mass of a charge control agent (quaternary ammonium salt compound, “BONTRON (registered trademark) P-51” made by Orient Chemical Industries Co., Ltd.), 40.00 parts by mass of magnetic particles (BK-a) (TN-15 (made by Mitsui Kinzoku Co., Ltd.)) and 0.50 parts by mass of the carbon nanotube (CN-A). The mixture was melt-kneaded with a twin-screw extruder, and thus a kneaded product was obtained. The kneaded product was coarsely pulverized with a pulverizer (“Rotoplex (registered trademark)” made by Toa Machinery Industry), and thus the coarsely pulverized product was obtained. The coarsely pulverized product was finely pulverized with a mechanical pulverizer (“Turbo Mill” made by Freund-Turbo Corporation), and thus the finely pulverized product was obtained. The finely pulverized product was classified with a classifier (“Elbow Jet” made by Nittetsu Mining Co., Ltd.), and thus a toner core was obtained. The volume median diameter of the obtained toner core was 7.0 μm. The obtained toner core was used as toner base particles.

### (External Addition Step)

100.0 parts by mass of the toner base particles obtained as described above, 2.0 parts by mass of titanium oxide particles (“EC-100” made by Titan Kogyo Ltd.) and 1.0 part by mass of hydrophobic silica particles (“RA-200H” made by Nippon Aerosil Co., Ltd.) were mixed for 5 minutes at a rotational peripheral speed of 30 m/s using an FM mixer (made by Nippon Coke and Engineering Co., Ltd.). In this way, external additives (the titanium oxide particles and the hydrophobic silica particles) were adhered to the surface of the toner base particles, and thus the toner (T-A1) was obtained.

### <Manufacturing of Toners (T-A2) and (T-A3) and (T-B1) and (T-B2)>

Toners (T-A2) and (T-A3) and (T-B1) and (T-B2) were manufactured by the same method as in the manufacturing of the toner (T-A1) except that the amounts of carbon nanotubes added in the toner core formation step were set as shown in Tables 1 and 3.

### <Manufacturing of Toners (T-A4) and (T-A5)>

Toners (T-A4) and (T-A5) were manufactured by the same method as in the manufacturing of the toner (T-A1) except that the types of carbon nanotubes used in the toner core formation step were set as shown in Table 1.

### <Manufacturing of Toners (T-A6) and (T-A7)>

Toners (T-A6) and (T-A7) were manufactured by the same method as in the manufacturing of the toner (T-A1) except that the amounts of magnetic particles used in the toner core formation step were set as shown in Table 2.

### <Manufacturing of Toner (T-A8)>

A toner (T-A8) was manufactured by the same method as in the manufacturing of the toner (T-A1) except that the type of magnetic particles (BK-b) used in the toner core formation step was set to MTS-106 (made by TODA KOGYO CORP.).

### <Manufacturing of Toners (T-B3) and (T-B4)>

Toners (T-B3) and (T-B4) were manufactured by the same method as in the manufacturing of the toner (T-A1) except that the amounts of magnetic particles used in the toner core formation step were set as shown in Table 2.

### <Manufacturing of Toner (T-B5)>

A toner (T-B5) was manufactured by the same method as in the manufacturing of the toner (T-A1) except that no carbon nanotube was added in the toner core formation step.

### <Manufacturing of Toner (T-A9)>

A toner (T-A9) was manufactured by the same method as in the manufacturing of the toner (T-A1) except that the shell layer formation step to be described below was performed after the toner core formation step and before the external addition step.

### (Shell Layer Formation Step)

In the formation of the shell layer, a powder treatment device (“Multipurpose Mixer MP type” made by Nippon Coke and Engineering Co., Ltd.) was used. 100 g of the toner core (specifically, the toner core obtained in the toner core formation step in the manufacturing of the toner (T-A1)) and 10 g of the resin particles (A) were placed into the treatment chamber of the powder treatment device, and were treated under conditions of a rotation speed of 8000 rpm and a treatment time of 15 minutes. During the treatment, the powder treatment device was controlled such that the temperature inside the chamber of the powder treatment device was in a range equal to or greater than 50° C. and equal to or less than 60° C. By the treatment described above, the toner core was covered with the resin particles (A), and thus the shell layer was formed on the surface of the toner core. Consequently, the toner base particles which included the toner core and the shell layer covering the toner core were obtained. The obtained toner base particles were used in the external addition step.

### [Measurement Method]

### <Volume Median Diameter>

The volume median diameter of the toner core described above was measured using a Coulter Counter Multisizer 4e (made by Beckman Coulter, Inc.).

### <Number Average Primary Particle Diameter>

The number average primary particle diameter of the resin particles described above was measured according to the following method. A photograph of the resin particles was shot at a magnification of 100,000 times using a field emission scanning electron microscope (JSM-6700F (made by JEOL Ltd.)). The electron microscope photograph shot was further enlarged as necessary, and the primary particle diameters of 50 resin particles were measured using a ruler, calipers or the like. The number average value of the primary particle diameters of 50 resin particles was assumed to be the number average primary particle diameter of the resin particles.

### [Evaluation Machine]

An evaluation machine used for the following evaluations was a color printer (ECOSYS (registered trademark) LS-2100DN made by KYOCERA Document Solutions Japan Inc.) which was modified to be able to adjust a fixing temperature.

### [Evaluation of Fixability]

The fixability (specifically, a lowest fixing temperature and a fixation rate) of each toner was evaluated by the following method. The results of the evaluations are shown in Tables 4 to 6 below.

### <Lowest Fixing Temperature>

A solid image (more specifically, an unfixed toner image) was formed on one sheet (sheet for both monochrome and color, “CC90” made by Fuji Xerox Co., Ltd., basis weight: 90 g/m²) using the evaluation machine in a normal temperature and normal humidity environment (at a temperature of 20° C. and a relative humidity of 65% RH). In the solid image, the amount of toner on the plane of sheet was 1.0 mg/cm², and its size was 30 mm×30 mm. Then, the sheet on which the solid image was formed was passed through the fixing device of the evaluation machine.

The fixing temperature of the fixing device was set equal to or greater than 100° C. and equal to or less than 145° C. Specifically, the fixing temperature of the fixing device was increased by 1° C. from 100° C., and the lowest temperature (lowest fixing temperature) at which the solid image (unfixed toner image) was fixed on the sheet was measured. Whether the unfixed toner image was fixed was checked by a folding/rubbing test which will be described below.

The sheet which had been passed through the fixing device was folded such that the surface on which the solid image was formed was directed inward. More specifically, the sheet was folded such that a fold line was passed through approximately the center of the solid image. A 1 kg weight covered with fabric was rubbed back and forth 10 times along the crease of the folded sheet such that only the weight of the weight was applied to the sheet. Thereafter, the sheet was unfolded, and the length of the peeled toner (peeling length) on a part where the solid image was fixed in the folded portion of the sheet was measured. When the peeling length was equal to or less than 1 mm, the unfixed toner image was determined to be fixed. The lowest fixing temperature was determined according to the following criteria. As the lowest fixing temperature of the toner is lowered, the low-temperature fixability of the toner is shown to be more excellent.

### (Criteria for Lowest Fixing Temperature)

A (satisfactory): lowest fixing temperature is equal to or less than 130° C.
B (poor): lowest fixing temperature is greater than 130° C. and less than 135° C.
C (particularly poor): lowest fixing temperature is equal to or greater than 135° C.

### <Fixation Rate>

The fixing temperature of the fixing device in the evaluation machine was set to 160° C. An image A (solid image having a print rate of 4%) was formed on one sheet (copy paper for both monochrome and color, “C2” made by FUJIFILM Business Innovation Corp., basis weight: 70 g/m²) using the evaluation machine in a normal temperature and normal humidity environment (at a temperature of 20° C. and a relative humidity of 65% RH). The formed image was used as an evaluation image. The image density (ID before rubbing) of the evaluation image was measured using a spectrodensitometer/colorimeter (“SpectroEye (registered trademark)” made by X-Rite, Inc.).

Then, the sheet was folded such that the surface on which the solid image was formed was directed inward. More specifically, the sheet was folded such that a fold line was passed through approximately the center of the solid image. A 1 kg weight covered with fabric was rubbed back and forth 10 times along the crease of the folded sheet such that only the weight of the weight was applied to the sheet. The image density (ID after rubbing) of the evaluation image after the rubbing was measured using the spectrodensitometer/colorimeter (“SpectroEye (registered trademark)” made by X-Rite, Inc.).

A fixation rate (unit: %) was calculated according to a formula “fixation rate=(ID after rubbing/ID before rubbing)×100”. The fixation rate was determined according to the following criteria.

### (Criteria for Fixation Rate)

A (satisfactory): fixation rate is equal to or greater than 95%
B (poor): fixation rate is equal to or greater than 90% and less than 95%
C (particularly poor): fixation rate is less than 90%

TABLE 4

| | | Example1 | Example2 | Example3 | Example4 | Example5 |
|---|---|---|---|---|---|---|
| Toner | | T-A1 | T-A2 | T-A3 | T-A4 | T-A5 |
| Lowest | Value [° C.] | 120 | 129 | 113 | 118 | 117 |
| fixing | Evaluation | A | A | A | A | A |
| Fixation | Value [%] | 96 | 95 | 97 | 96 | 96 |
| rate | Evaluation | A | A | A | A | A |

TABLE 5

| | | Example6 | Example7 | Example8 | Example9 |
|---|---|---|---|---|---|
| Toner | | T-A6 | T-A7 | T-A8 | T-A9 |
| Lowest | Value [° C.] | 112 | 128 | 121 | 125 |
| fixing | Evaluation | A | A | A | A |
| Fixation | Value [%] | 99 | 95 | 95 | 95 |
| rate | Evaluation | A | A | A | A |

TABLE 6

| | | Comparative | Comparative | Comparative | Comparative | Comparative |
|---|---|---|---|---|---|---|
| | | example1 | example2 | example3 | example4 | example5 |
| Toner | | T-A1 | T-A2 | T-B3 | T-B4 | T-B5 |
| Lowest | Value [° C.] | 132 | 110 | 107 | 135 | 136 |
| fixing | Evaluation | B | A | A | B | C |
| Fixation | Value [%] | 94 | 99 | 99 | 90 | 90 |
| rate | Evaluation | B | A | A | B | B |

### [Evaluations of Image Density, Toner Charge Amount and Fog in Normal Temperature and Normal Humidity Environment]

An initial image density, an initial toner charge amount and initial fog were evaluated for each toner by the following method. An image density and a toner charge amount after continuous image formation were evaluated for each toner by the following method. An evaluation environment was set to a normal temperature and normal humidity environment (environment of a temperature of 20° C. and a relative humidity of 65% RH which is hereinafter referred to as the “NN environment”). The results of the evaluations are shown in Tables 7 to 9 below.

### <Image Formation>

The fixing temperature of the fixing device in the evaluation machine was set to 160° C. An image A (solid image having a print rate of 4%) was formed on one sheet (copy paper for both monochrome and color, “C2” made by FUJIFILM Business Innovation Corp., basis weight: 70 g/m²) using the evaluation machine, and the image A was assumed to be an initial image. Then, an image B (blank image) was formed on one sheet using the evaluation machine, and the image B was assumed to be a fog evaluation image. Then, an image C (image having a print rate of 4%) was continuously formed on 2500 sheets using the evaluation machine. Then, the image A was formed on one sheet again using the evaluation machine, and the image A was assumed to be a post-printing image.

### <Image Density>

The image density (initial ID) of the initial image obtained by the image formation described above was measured using a reflection densitometer (“RD914” made by X-Rite Inc.). The image density (post-printing ID) of the post-printing image obtained by the image formation described above was measured using the reflection densitometer (“RD914” made by X-Rite Inc.). The image density was determined according to the following criteria.

### (Criteria for Image Density)

A (satisfactory): ID is equal to or greater than 1.25
B (poor): ID is equal to or greater than 1.20 and less than 1.25
C (particularly poor): ID is less than 1.20

### <Fog>

The reflection density DA of the fog evaluation image (blank image) obtained by the image formation described above was measured using the reflection densitometer (“RD914” made by X-Rite Inc.). The reflection density DB of an unprinted sheet was measured using the reflection densitometer (“RD914” made by X-Rite Inc.). A fog density (FD) was calculated from a formula “fog density=reflection density DA-reflection density DB”. The fog was determined according to the following criteria.

### (Criteria for Fog)

A (satisfactory): FD is equal to or less than 0.010
B (poor): FD is greater than 0.010

### <Toner Charge Amount>

After the initial image was formed in the image formation described above, the charge amount (initial charge amount) of toner in the development unit of the evaluation machine was measured using a charge amount measuring device (“Q/M Meter 210HS” made by Trex Company). After the post-printing image was formed in the image formation described above, the charge amount (post-printing charge amount) of toner on the development roll of the evaluation machine was measured using the charge amount measuring device (“Q/M Meter 210HS” made by Trex Company). The toner charge amount was determined according to the following criteria.

### (Criteria for Toner Charge Amount)

A (satisfactory): charge amount is equal to or greater than 20.0 μC/g and equal to or less than 25.0 μC/g
B (poor): charge amount is equal to or greater than 19.0 μC/g and less than 20.0 μC/g, or is greater than 25.0 μC/g and equal to or less than 26.0 μC/g
C (particularly poor): charge amount is less than 19.0 μC/g, or is greater than 26.0 μC/g

TABLE 7

| NN Environment | | | Example1 | Example2 | Example3 | Example4 | Example5 |
|---|---|---|---|---|---|---|---|
| Toner | | | T-A1 | T-A2 | T-A3 | T-A4 | T-A5 |
| Initial | ID | Value | 1.28 | 1.27 | 1.32 | 1.29 | 1.29 |
| | | Evaluation | A | A | A | A | A |
| | Charge | Value | 23.2 | 24.1 | 20.2 | 23.2 | 22 |
| | amount | [μC/g] | | | | | |
| | | Evaluation | A | A | A | A | A |
| | FD | Value | 0.003 | 0.002 | 0.009 | 0.004 | 0.005 |
| | | Evaluation | A | A | A | A | A |
| Post- | ID | Value | 1.28 | 1.29 | 1.33 | 1.28 | 1.27 |
| printing | | Evaluation | A | A | A | A | A |
| | Charge | Value | 23.3 | 23.9 | 20.4 | 23.1 | 22.4 |
| | amount | [μC/g] | | | | | |
| | | Evaluation | A | A | A | A | A |

TABLE 8

| NN Environment | | | Example6 | Example7 | Example8 | Example9 |
|---|---|---|---|---|---|---|
| Toner | | | T-A6 | T-A7 | T-A8 | T-A9 |
| Initial | ID | Value | 1.26 | 1.30 | 1.30 | 1.26 |
| | | Evaluation | A | A | A | A |
| | Charge | Value | 21.5 | 22.3 | 23 | 23.3 |
| | amount | [μC/g] | | | | |
| | | Evaluation | A | A | A | A |
| | FD | Value | 0.009 | 0.001 | 0.007 | 0.002 |
| | | Evaluation | A | A | A | A |
| Post- | ID | Value | 1.26 | 1.33 | 1.3 | 1.27 |
| printing | | Evaluation | A | A | A | A |
| | Charge | Value | 21.6 | 23 | 23.1 | 23.4 |
| | amount | [μC/g] | | | | |
| | | Evaluation | A | A | A | A |

TABLE 9

| | | | Comparative | Comparative | Comparative | Comparative | Comparative |
|---|---|---|---|---|---|---|---|
| NN Environment | | | example1 | example2 | example3 | example4 | example5 |
| Toner | | | T-B1 | T-B2 | T-B3 | T-B4 | T-B5 |
| Initial | ID | Value | 1.26 | 1.32 | 1.19 | 1.29 | 1.25 |
| | | Evaluation | A | A | C | A | A |
| | Charge | Value | 24 | 19.8 | 20.1 | 23 | 24.3 |
| | amount | [μC/g] | | | | | |
| | | Evaluation | A | B | A | A | A |
| | FD | Value | 0.001 | 0.012 | 0.012 | 0.002 | 0.002 |
| | | Evaluation | A | B | B | A | A |
| Post- | ID | Value | 1.25 | 1.33 | 1.21 | 1.29 | 1.26 |
| printing | | Evaluation | A | A | A | A | A |
| | Charge | Value | 24.2 | 20 | 20.4 | 23.2 | 25 |
| | amount | [μC/g] | | | | | |
| | | Evaluation | A | A | A | A | A |

### [Evaluations of Image Density, Toner Charge Amount and Fog in High Temperature and High Humidity Environment]

An image density, a toner charge amount and fog in a HH environment were evaluated by the same method as in the evaluations of the image density, the toner charge amount and the fog in a NN environment except that the evaluation environment was changed from the NN environment to a high temperature and high humidity environment (environment of a temperature of 32.5° C. and a relative humidity of 80% RH which is hereinafter referred to as the “HH environment”). The results of the evaluations are shown in Tables 10 to 12 below.

TABLE 10

| HH Environment | | | Example1 | Example2 | Example3 | Example4 | Example5 |
|---|---|---|---|---|---|---|---|
| Toner | | | T-A1 | T-A2 | T-A3 | T-A4 | T-A5 |
| Initial | ID | Value | 1.26 | 1.28 | 1.35 | 1.28 | 1.26 |
| | | Evaluation | A | A | A | A | A |
| | Charge | Value | 22.5 | 23.4 | 20 | 22.8 | 22 |
| | amount | [μC/g] | | | | | |
| | | Evaluation | A | A | A | A | A |
| | FD | Value | 0.005 | 0.003 | 0.01 | 0.005 | 0.007 |
| | | Evaluation | A | A | A | A | A |
| Post- | ID | Value | 1.27 | 1.28 | 1.36 | 1.28 | 1.27 |
| printing | | Evaluation | A | A | A | A | A |
| | Charge | Value | 22.4 | 23.1 | 20.4 | 22.8 | 22.3 |
| | amount | [μC/g] | | | | | |
| | | Evaluation | A | A | A | A | A |

TABLE 11

| HH Environment | | | Example6 | Example7 | Example8 | Example9 |
|---|---|---|---|---|---|---|
| Toner | | | T-A6 | T-A7 | T-A8 | T-A9 |
| Initial | ID | Value | 1.25 | 1.29 | 1.29 | 1.26 |
| | | Evaluation | A | A | A | A |
| | Charge | Value | 21 | 22.1 | 22.1 | 22.6 |
| | amount | [μC/g] | | | | |
| | | Evaluation | A | A | A | A |
| | FD | Value | 0.01 | 0.002 | 0.008 | 0.003 |
| | | Evaluation | A | A | A | A |
| Post- | ID | Value | 1.26 | 1.28 | 1.29 | 1.27 |
| printing | | Evaluation | A | A | A | A |
| | Charge | Value | 21.1 | 22.3 | 22.4 | 22.8 |
| | amount | [μC/g] | | | | |
| | | Evaluation | A | A | A | A |

TABLE 12

| | | | Comparative | Comparative | Comparative | Comparative | Comparative |
|---|---|---|---|---|---|---|---|
| HH Environment | | | example1 | example2 | example3 | example4 | example5 |
| Toner | | | T-B1 | T-B2 | T-B3 | T-B4 | T-B5 |
| Initial | ID | Value | 1.25 | 1.35 | 1.18 | 1.27 | 1.25 |
| | | Evaluation | A | A | C | A | A |
| | Charge | Value | 23.2 | 19.5 | 19 | 22.5 | 23.8 |
| | amount | [μC/g] | | | | | |
| | | Evaluation | A | B | B | A | A |
| | FD | Value | 0.005 | 0.013 | 0.015 | 0.004 | 0.003 |
| | | Evaluation | A | B | B | A | A |
| Post- | ID | Value | 1.25 | 1.36 | — | 1.28 | 1.25 |
| printing | | Evaluation | A | A | — | A | A |
| | Charge | Value | 23.5 | 20.1 | — | 22.2 | 24.3 |
| | amount | [μC/g] | | | | | |
| | | Evaluation | A | A | — | A | A |

In Table 12, “-” indicates that the evaluation machine was not operated properly and the evaluation was not able to be performed.

### [Evaluations of Image Density, Toner Charge Amount and Fog in Low Temperature and Low Humidity Environment]

An image density, a toner charge amount and fog in a LL environment were evaluated by the same method as in the evaluations of the image density, the toner charge amount and the fog in the NN environment except that the evaluation environment was changed from the NN environment to a low temperature and low humidity environment (environment of a temperature of 10° C. and a relative humidity of 20% RH which is hereinafter referred to as the “LL environment”). The results of the evaluations are shown in Tables 13 to 15 below.

TABLE 13

| LL Environment | | | Example1 | Example2 | Example3 | Example4 | Example5 |
|---|---|---|---|---|---|---|---|
| Toner | | | T-A1 | T-A2 | T-A3 | T-A4 | T-A5 |
| Initial | ID | Value | 1.3 | 1.28 | 1.33 | 1.31 | 1.29 |
| | | Evaluation | A | A | A | A | A |
| | Charge | Value | 24.2 | 24.6 | 22 | 24 | 23.8 |
| | amount | [μC/g] | | | | | |
| | | Evaluation | A | A | A | A | A |
| | FD | Value | 0.001 | 0.001 | 0.005 | 0.003 | 0.003 |
| | | Evaluation | A | A | A | A | A |
| Post- | ID | Value | 1.29 | 1.29 | 1.3 | 1.3 | 1.28 |
| printing | | Evaluation | A | A | A | A | A |
| | Charge | Value | 24 | 24.3 | 22.1 | 24.1 | 23.7 |
| | amount | [μC/g] | | | | | |
| | | Evaluation | A | A | A | A | A |

TABLE 14

| LL Environment | | | Example6 | Example7 | Example8 | Example9 |
|---|---|---|---|---|---|---|
| Toner | | | T-A6 | T-A7 | T-A8 | T-A9 |
| Initial | ID | Value | 1.27 | 1.32 | 1.32 | 1.29 |
| | | Evaluation | A | A | A | A |
| | Charge | Value | 23 | 23.4 | 24 | 24.5 |
| | amount | [μC/g] | | | | |
| | | Evaluation | A | A | A | A |
| | FD | Value | 0.008 | 0.001 | 0.003 | 0.002 |
| | | Evaluation | A | A | A | A |
| Post- | ID | Value | 1.29 | 1.33 | 1.31 | 1.3 |
| printing | | Evaluation | A | A | A | A |
| | Charge | Value | 23.2 | 23.4 | 23.8 | 24.5 |
| | amount | [μC/g] | | | | |
| | | Evaluation | A | A | A | A |

TABLE 15

| | | | Comparative | Comparative | Comparative | Comparative | Comparative |
|---|---|---|---|---|---|---|---|
| LL Environment | | | example1 | example2 | example3 | example4 | example5 |
| Toner | | | T-B1 | T-B2 | T-B3 | T-B4 | T-B5 |
| Initial | ID | Value | 1.28 | 1.34 | 1.25 | 1.33 | 1.26 |
| | | Evaluation | A | A | A | A | A |
| | Charge | Value | 24.8 | 21.3 | 21.7 | 23.8 | 25 |
| | amount | [μC/g] | | | | | |
| | | Evaluation | A | A | A | A | A |
| | FD | Value | 0 | 0.008 | 0.011 | 0.001 | 0.001 |
| | | Evaluation | A | A | B | A | A |
| Post- | ID | Value | 1.27 | 1.32 | 1.26 | 1.31 | 1.26 |
| printing | | Evaluation | A | A | A | A | A |
| | Charge | Value | 24.4 | 21 | 21.5 | 23.4 | 24.8 |
| | amount | [μC/g] | | | | | |
| | | Evaluation | A | A | A | A | A |

In the toner (T-B1), the content of the carbon nanotube in the toner core was less than 0.10% by mass. The evaluation of the fixability of the toner (T-B1) was poor.

In the toner (T-B2), the content of the carbon nanotube in the toner core was greater than 1.00% by mass. The evaluation of the initial charge amount of the toner (T-B2) in the NN environment was poor. The evaluations of the post-printing charge amounts of the toner (T-B2) in the NN environment and the HH environment were particularly poor. The evaluation of the initial fog of the toner (T-B2) in the NN environment was poor.

In the toner (T-B3), the content of the magnetic particle in the toner core was less than 30.00% by mass. The evaluation of the initial charge amount of the toner (T-B3) in the HH environment was poor. The evaluation of the initial image density of the toner (T-B3) in the HH environment was particularly poor. The evaluation of the post-printing image density of the toner (T-B3) in the HH environment was particularly poor. The evaluation of the post-printing charge amount of the toner (T-B3) in the HH environment was particularly poor. The evaluations of the initial fog of the toner (T-B3) in the NN environment, the LL environment and the HH environment were particularly poor.

In the toner (T-B4), the content of the magnetic particle in the toner core was greater than 50.00% by mass. The evaluation of the fixability of the toner (T-B4) was poor.

In the toner (T-B5), the toner core contained no carbon nanotube. The evaluation of the fixability of the toner (T-B5) was particularly poor.

On the other hand, each of the toners (T-A1) to (T-A9) included the toner particle. The toner particle included the toner core. The toner core contained the binding resin, the magnetic particle and the carbon nanotube. The content of the magnetic particle in the toner core was equal to or greater than 30.0% by mass and equal to or less than 50.0% by mass, and the content of the carbon nanotube was equal to or greater than 0.10% by mass and equal to or less than 1.00% by mass. In the toners (T-A1) to (T-A9), the evaluations of the fixability, the evaluations of the initial and post-printing charge amounts in various environments (for example, the NN environment, the HH environment and the LL environment), the evaluations of the initial and post-printing image densities in various environments (for example, the NN environment, the HH environment and the LL environment) and the evaluations of the initial fog in various environments (for example, the NN environment, the HH environment and the LL environment) were all satisfactory.

Therefore, it is determined that the toner in the present disclosure which includes the toners (T-A1) to (T-A9) has excellent fixability, can be charged to a desired charge amount and can form images with a desired density and a small amount of fog even when images are continuously formed under various environments such as a normal temperature and normal humidity environment, a high temperature and high humidity environment and a low temperature and low humidity environment.

The toner in the present disclosure can be used for forming images in, for example, a copying machine, a printer or a multifunctional peripheral.

What is claimed is:

1. A toner comprising:
a toner particle,
wherein the toner particle includes a toner core,
the toner core contains:
a binding resin;
a magnetic particle; and
a carbon nanotube,
a content of the magnetic particle in the toner core is equal to or greater than 30.0% by mass and equal to or less than 50.0% by mass and
a content of the carbon nanotube in the toner core is equal to or greater than 0.10% by mass and equal to or less than 1.00% by mass.

2. The toner according to claim 1,
wherein the carbon nanotube is a single-walled carbon nanotube or a multi-walled carbon nanotube.

3. The toner according to claim 1,
wherein the toner particle is an encapsulated toner particle that includes the toner core and a shell layer covering a surface of the toner core or
the toner particle is a non-encapsulated toner particle that includes the toner core but does not include the shell layer.

4. The toner according to claim 1,
wherein the toner particle does not include the carbon nanotube as an external additive.
